(19) United States
(12) Patent Application Publication
(10) Pub. No.: US 2022/0250966 A1
(43) Pub. Date: Aug. 11, 2022

(54) NEGATIVE COLOR SHIFT GLASSES AND LIGHT GUIDE PLATES

(71) Applicant: Corning Incorporated, Corning, NY (US)

(72) Inventors: Melissann Marie Ashton-Patton, Corning, NY (US); Ellen Anne King, Corning, NY (US)

(21) Appl. No.: 17/612,402

(22) PCT Filed: May 15, 2020
(86) PCT No.: PCT/US2020/033050

§ 371 Date: Nov. 18, 2021

Related U.S. Application Data
(60) Provisional application No. 62/851,779, filed on May 23, 2019.

(51) Int. Cl. C03C 3/093; F21V 8/00; C03C 4/08

(52) U.S. Cl. CPC C03C 3/093; C03C 4/08; G02B 6/0038; G02B 6/0065

(57) ABSTRACT

Glasses, glass light guide plates and display products comprising light guide plates are disclosed. Glasses are disclosed having a negative color shift. A light guide plate that includes a glass substrate including an edge surface and two major surfaces defining a thickness and an edge surface configured to receive light from a light source and the glass substrate configured to distribute the light from the light source. Methods of processing glass compositions to form a substrate for use as a light guide plate are also provided.

### CROSS-REFERENCE TO RELATED APPLICATIONS

This application claims the benefit of priority of U.S. Provisional Application Ser. No. 62/851,779 filed on May 23, 2019 the contents of which are relied upon and incorporated herein by reference in their entity as if fully set forth below.

### FIELD

The disclosure relates to glasses exhibiting negative color shift, and glass substrates made from such glasses that can be used, for example, in displays comprising a light guide plate.

### BACKGROUND

While organic light emitting diode (OLED) display devices are gaining in popularity, costs to produce these display devices are still high, and liquid crystal display (LCD) devices still comprise the large majority of display devices sold, particularly large panel size devices, such as television sets and other large-format devices such as commercial signs. Unlike OLED display panels, LCD panels do not themselves emit light, and are therefore dependent on a backlight unit (BLU) including a light guide plate (LGP) positioned behind the LCD panel to provide transmissive light to the LCD panel. Light from the BLU illuminates the LCD panel and the LCD panel functions as a light valve that selectively allows light to pass through pixels of the LCD panel or be blocked, thereby forming a viewable image.

LCDs are commonly used in various electronics, such as cell phones, laptops, electronic tablets, televisions, and computer monitors. Increased demand for thinner, larger, high-resolution flat panel displays drives the need for high-quality substrates for use in the display, e.g., as LGPs. As such, there is a desire in the industry for thinner LGPs with higher light coupling efficiency and/or light output, which may allow for a decrease in the thickness and/or an increase in the screen size of various display devices.

Typical light guide plates incorporate a polymer light guide, such as poly methyl methacrylate (PMMA). PMMA is easily formed, and can be molded or machined to facilitate local dimming. However, PMMA can suffer from thermal degradation, comprises a relatively large coefficient of thermal expansion, suffers from moisture absorption and is easily deformed. On the other hand, glass is dimensionally stable (comprises a relatively low coefficient of thermal expansion), and can be produced in large thin sheets suitable for the growing popularity of large, thin TVs.

While glass light guide plates (“GLGPs”) do not suffer from these aforementioned disadvantages of polymeric light guide plates, there is still a need to improve GLGPs. In LCDs, the GLGP is between layers of optical films, and a reflector film or reflector features (lenticular features, quantum dots, etc.). The reflector films direct the light from the vertical plane of the GLGP towards the LCD, and the optical films condition the light for the LCDs. When white light interacts with these layers and the GLGP, some light is lost to scattering and absorption. This loss of light leads to what the industry calls color shift. Color is plotted in a 3D coordinate system, wherein a shift in the Δy color space is the most obvious to the human eye. Systems with high (positive) Δy color shift no longer appear white, and instead, the human eye sees yellow. Optical components currently used in LCDs, including GLGPs, optical films and reflecting films, lead to positive color shift. There is a need to provide GLGPs exhibiting improved color shift.

### SUMMARY

One aspect of the present disclosure provides a light guide plate comprising a glass substrate comprising two major surfaces defining a thickness and an edge surface configured to receive light from a light source and the glass substrate configured to distribute the light from the light source, the glass substrate containing amounts of Fe, Cr and Ni metals such that the glass substrate exhibits a measured color shift Δy that is negative. In some embodiments, the glass substrate comprises a greater amount of a Fe³⁺ state relative to a Fe²⁺ state.

A second aspect of the present disclosure provides a method of processing a glass substrate for use as a light guide plate, the method comprising selecting raw materials for a glass batch and processing the raw materials to provide a glass composition; forming the glass composition into the glass substrate comprising two major surfaces defining a thickness and an edge surface, the glass composition containing amounts of Fe, Cr and Ni metals such that the glass substrate exhibits a negative measured color shift Δy. In some embodiments of the method, the glass substrate comprises a greater amount of a Fe³⁺ state relative to a Fe²⁺ state.

In some embodiments of the method, transmission of light at 450 nm, T_{450 nm}, and transmission of light at 550 nm, T_{550 nm}, through the glass substrate satisfies the following equation: T_{450 nm}−T_{550 nm}≥−0.3.

### BRIEF DESCRIPTION OF THE DRAWINGS

The following detailed description can be further understood when read in conjunction with the following drawings.

FIG. 1 is a cross-sectional view of an exemplary LCD display device;

FIG. 2 is a top view of an exemplary light guide plate;

FIG. 3 illustrates a light guide plate according to certain embodiments of the disclosure;

FIG. 4 is a graph which shows the overall absorption curve of Fe, which is composed of both Fe²⁺ and Fe³⁺ redox states, in a prior art glass composition used in the manufacture of glass light guide plates;

FIG. 5 is a graph which depicts the transmission of seven exemplary glass compositions and one comparative glass composition which can be used in the manufacture of glass light guide plates;

FIG. 6 is a graph plotting color shift against elemental Fe concentration for 3 glass compositions;

FIG. 7 is a graph plotting absorption versus wavelength for three glass compositions;

FIG. 8 is a graph of color shift versus plotting color shift against elemental Ni concentration for three glass compositions;

FIG. 9 is a graph plotting absorption versus wavelength for three glass compositions;

FIG. 10 is a graph of color shift versus plotting color shift against elemental Cr concentration for three glass compositions.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Embodiments of the disclosure provide glasses having a negative color shift, glass light guide plates made from such glasses and display devices incorporating light guide plates. According to one or more embodiments, glasses and glass light guide are processed to a negative Δy color shift via control of the metal oxide concentration, the redox state of the metal oxides, and the glass chemistry.

The concentration and constitution of the metal oxides (Fe, Cr and Ni oxides) present in the glass is a function of the type and purity of the materials used in the glass batch, as well as the supplemental metal contamination that occurs during cullet crushing and handling processes. Iron is the most abundant tramp metal in glass forming raw materials, and it is present in every raw material utilized in glass compositions used in the manufacture of glass light guide plates. Although the removal of all Fe from these raw materials is theoretically possible, generally, the cost of doing so is prohibitive to glass manufacturing processes. The majority of Cr and Ni in glass compositions used in the manufacture of glass light guide plates is due to the use of Al₂O₃ as a raw material, as both metals are naturally present as impurities in the Al₂O₃ structure. In embodiments of the disclosure in which the glass composition is free of Al₂O₃, Cr and Ni contamination is due to the metal equipment that contacts the glass during the glass cullet crushing process. Changing to alternative glass cullet crushing equipment made from materials that either wears less, or do not contain Ni and Cr, could significantly reduce the concentration of these contaminants in the final glass product. In some embodiments, tramp metal content could be adjusted by adding a reducing or oxidizing agent to the glass batch materials for the glass compositions.

Each of the aforementioned metals (Fe, Cr, and Ni) absorbs light in the visible spectrum, and with the exception of Ni, can be present in a glass composition in more than one redox state. It has been determined that the presence of these metals in specific concentration ratios and redox states defines the ability to achieve negative color shift. The concentration of the metals in a glass composition can be manipulated via the purity of the batch materials and the cullet crushing equipment materials used in the cullet handling process. Redox states for the individual metals are more complicated. To some extent, the redox state of metals in the final glass product is determined by the type of manufacturing process (e.g., fusion or float), the atmosphere used in that process, and the residence time of the glass in the tank. However in any given comparable processes, the redox state is also affected by the composition chemistry. Therefore understanding compositional effects on redox state and thus absorption spectra for each metal is paramount to creating negative color shift. According to one or more embodiments of this disclosure, the absorption spectra of the individual metals, their relative redox states and the relation to glass chemistry, and the effect of concentration on color shift are described.

An aspect of the disclosure pertains to a method of processing a glass substrate for use as a light guide plate to provide a glass substrate exhibits a negative color shift. The method can include selecting raw materials for a glass batch and processing the raw materials to provide a glass composition. The raw materials can contain amounts of Fe, Cr and Ni to achieve a desired color shift. In one or more embodiments, processing of the glass composition, such as crushing and or handling of the glass cullet is conducted in a way to control levels of Fe, Cr and Ni. The method further comprises forming the glass composition into the glass substrate comprising two major surfaces defining a thickness and an edge surface, wherein the glass composition contains amounts of Fe, Cr and Ni metals such that the glass exhibits a measured color shift Δy that is negative.

Fe has two well-known redox states, both of which are present in any given glass composition, Fe²⁺ and Fe³⁺. Although the equilibrium between these two states can be affected via the manufacturing process, it has been determined that the redox equilibrium between Fe²⁺ and Fe³⁺ is largely dictated by the chemistry of the glass matrix. Additionally, the extinction coefficient for each redox state (absorption per ion), is also a function of the glass chemistry. Due to its abundance relative to all other metals in certain glass batches according to one or more embodiments described herein, the Fe content of the glass serves to set the base glass color shift. Any chemistry that encourages either a greater amount of Fe in the Fe³⁺ state or a high extinction coefficient for the Fe³⁺ state, will suffer from a higher color shift than those chemistries that stabilize the Fe²⁺. This is due to the higher absorption of Fe³⁺ in the blue region of the spectrum.

In glass compositions used for manufacturing GLGPs, Cr, Fe and Ni will be present in the glass at some level. The individual concentration of these metals relative to one another determines the overall color shift of the glass. Regardless of the exact level of each metal, according to one or more embodiments, it was determined that a particular glass composition exhibits a negative color shift as long as the following equation is satisfied:

$$Δ {y}_{n e g a t i v e} = {T}_{450 n m} - {T}_{550 n m} \geq - 0.3 .$$

In some embodiments, when a glass composition exhibits a negative color shift as long as the following equation is satisfied:

$$Δ {y}_{n e g a t i v e} = {T}_{450 n m} - {T}_{550 n m} \geq - 0.2 .$$

When the transmission of light at 550 nm is subtracted from the transmission of light at 450 nm through a glass substrate is greater than or equal to −0.3, and in some embodiments, greater than or equal to −0.0.2, then the glass composition exhibits a negative color shift. The Examples provide compositions that demonstrate this principle.

In one or more embodiments, a glass substrate used for a GLGP has any desired size and/or shape as appropriate to produce a desired light distribution. The glass substrate comprises a first major surface that emits light and a second major surface opposite the first major surface. In some embodiments, the first and second major surfaces are planar or substantially planar, e.g., substantially flat. The first and second major surfaces of various embodiments are parallel or substantially parallel. The glass substrate of some embodiments includes four edges, or may comprise more than four edges, e.g. a multi-sided polygon. In other embodiments, the glass substrate comprises less than four edges, e.g., a triangle. The light guide plate of various embodiments comprises a rectangular, square, or rhomboid sheet having four edges, although other shapes and configurations can be employed.

The glass substrate used for the GLGP comprises any material known in the art for use in display devices. In exemplary embodiments, the glass substrate comprises aluminosilicate, alkali-aluminosilicate, borosilicate, alkali-borosilicate, aluminoborosilicate, alkali-aluminoborosilicate, soda-lime, or other suitable glasses. In one embodiment, the glass is selected from an aluminosilicate glass, a borosilicate glass and a soda-lime glass. Examples of commercially available glasses suitable for use as a glass light guide plate include, but are not limited to, Iris™ and Gorilla® glasses from Corning Incorporated.

In one or more embodiments, the glass substrate used for the GLGP comprises, in mol %, ranges of the following oxides:
50-90 mol % SiO₂,
0-20 mol % Al₂O₃,
0-20 mol % B₂O₃, and
0-25 mol % RₓO, wherein x is 2 and R is chosen from Li, Na, K, Rb, Cs, and combinations thereof, or wherein x is 1 and R is chosen from Zn, Mg, Ca, Sr, Ba, and combinations thereof, and wherein the glass substrate comprises 0.5-20 mol % of one oxide selected from Li₂O, Na₂O, K₂O and MgO. In one or more embodiments, the glass substrate used for the GLGP comprises on a mol % oxide basis at least 3.5-20 mol %, 5-20 mol %, 10-20 mol % of one oxide selected from Li₂O, Na₂O, K₂O and MgO.

In one or more embodiments, the glass substrate used for the GLGP comprises an aluminosilicate glass comprising at least one oxide selected from alkali oxides such as Li₂O, Na₂O, K₂O and alkaline earth oxides, e.g., CaO and MgO, rendering the glass substrate susceptible to weathering products upon exposure to aging conditions described herein. In one or more embodiments, the glass substrate comprises, in mol %, ranges of the following oxides:
SiO₂: from about 65 mol % to about 85 mol %;
Al₂O₃: from about 0 mol % to about 13 mol %;
B₂O₃: from about 0 mol % to about 12 mol %;
Li₂O: from about 0 mol % to about 2 mol %;
Na₂O: from about 0 mol % to about 14 mol %;
K₂O: from about 0 mol % to about 12 mol %;
ZnO: from about 0 mol % to about 4 mol %;
MgO: from about 0 mol % to about 12 mol %;
CaO: from about 0 mol % to about 5 mol %;
SrO: from about 0 mol % to about 7 mol %;
BaO: from about 0 mol % to about 5 mol %; and
SnO₂: from about 0.01 mol % to about 1 mol %.

In one or more embodiments, the glass substrate used for the GLGP comprises, in mol %, ranges of the following oxides:
SiO₂: from about 70 mol % to about 85 mol %;
Al₂O₃: from about 0 mol % to about 5 mol %;
B₂O₃: from about 0 mol % to about 5 mol %;
Li₂O: from about 0 mol % to about 2 mol %;
Na₂O: from about 0 mol % to about 10 mol %;
K₂O: from about 0 mol % to about 12 mol %;
ZnO: from about 0 mol % to about 4 mol %;
MgO: from about 3 mol % to about 12 mol %;
CaO: from about 0 mol % to about 5 mol %;
SrO: from about 0 mol % to about 3 mol %;
BaO: from about 0 mol % to about 3 mol %; and
SnO₂: from about 0.01 mol % to about 0.5 mol %.

In one or more embodiments, the glass substrate comprises, in mol %, ranges of the following oxides:
SiO₂: from about 72 mol % to about 82 mol %;
Al₂O₃: from about 0 mol % to about 4.8 mol %;
B₂O₃: from about 0 mol % to about 2.8 mol %;
Li₂O: from about 0 mol % to about 2 mol %;
Na₂O: from about 0 mol % to about 9.3 mol %;
K₂O: from about 0 mol % to about 10.6 mol %;
ZnO: from about 0 mol % to about 2.9 mol %;
MgO: from about 3.1 mol % to about 10.6 mol %;
CaO: from about 0 mol % to about 4.8 mol %;
SrO: from about 0 mol % to about 1.6 mol %;
BaO: from about 0 mol % to about 3 mol %; and
SnO₂: from about 0.01 mol % to about 0.15 mol %.

In one or more embodiments, the glass substrate used for the GLGP comprises, in mol %, ranges of the following oxides:
SiO₂: from about 80 mol % to about 85 mol %;
Al₂O₃: from about 0 mol % to about 0.5 mol %;
B₂O₃: from about 0 mol % to about 0.5 mol %;
Li₂O: from about 0 mol % to about 2 mol %;
Na₂O: from about 0 mol % to about 0.5 mol %;
K₂O: from about 8 mol % to about 11 mol %;
ZnO: from about 0.01 mol % to about 4 mol %;
MgO: from about 6 mol % to about 10 mol %;
CaO: from about 0 mol % to about 4.8 mol %;
SrO: from about 0 mol % to about 0.5 mol %;
BaO: from about 0 mol % to about 0.5 mol %; and
SnO₂: from about 0.01 mol % to about 0.11 mol %.

In one or more embodiments, the glass substrate used for the GLGP comprises, in mol %, ranges of the following oxides:
SiO₂: from about 65.8 mol % to about 78.2 mol %;
Al₂O₃: from about 2.9 mol % to about 12.1 mol %;
B₂O₃: from about 0 mol % to about 11.2 mol %;
Li₂O: from about 0 mol % to about 2 mol %;
Na₂O: from about 3.5 mol % to about 13.3 mol %;
K₂O: from about 0 mol % to about 4.8 mol %;
ZnO: from about 0 mol % to about 3 mol %;
MgO: from about 0 mol % to about 8.7 mol %;
CaO: from about 0 mol % to about 4.2 mol %;
SrO: from about 0 mol % to about 6.2 mol %;
BaO: from about 0 mol % to about 4.3 mol %; and
SnO₂: from about 0.07 mol % to about 0.11 mol %.

In one or more embodiments, the glass substrate used for the GLGP comprises, in mol %, ranges of the following oxides:
SiO₂: from about 66 mol % to about 78 mol %;
Al₂O₃: from about 4 mol % to about 11 mol %;
B₂O₃: from about 40 mol % to about 11 mol %;
Li₂O: from about 0 mol % to about 2 mol %;
Na₂O: from about 4 mol % to about 12 mol %;
K₂O: from about 0 mol % to about 2 mol %;
ZnO: from about 0 mol % to about 2 mol %;
MgO: from about 0 mol % to about 5 mol %;
CaO: from about 0 mol % to about 2 mol %;
SrO: from about 0 mol % to about 5 mol %;
BaO: from about 0 mol % to about 2 mol %; and
SnO₂: from about 0.07 mol % to about 0.11 mol %.

In one or more embodiments, the glass substrate used for the GLGP comprising the compositions provided herein comprises a negative color shift as measured by a colorimeter.

In one or more embodiments, the compositions provided herein are characterized by RₓO/Al₂O₃ being in a range of from 0.95 to 3.23, where x=2 and R is any one or more of Li, Na, K, Rb, and Cs. In one or more embodiments, R is any one of Zn, Mg, Ca, Sr or Ba, x=1 and RₓO/Al₂O₃ is in a range of from 0.95 to 3.23. In one or more embodiments, R is any one or more of Li, Na, K, Rb and Cs, x=2 and RₓO/Al₂O₃ is in a range of from 1.18 to 5.68. In one or more embodiments, R is any one or more of Zn, Mg, Ca, SR or Ba, x=1 and RₓO/Al₂O₃ is in a range of from 1.18 to 5.68. Suitable specific compositions for glass substrates according to one or more embodiments are described in International Publication Number WO2017/070066.

In one or more embodiments, glass substrates used for the GLGP contain some alkali constituents, e.g., the glass substrates are not alkali-free glasses. As used herein, an “alkali-free glass” is a glass having a total alkali concentration which is less than or equal to 0.1 mole percent, where the total alkali concentration is the sum of the Na₂O, K₂O, and Li₂O concentrations. In some embodiments, the glass comprises Li₂O in the range of about 0 to about 3.0 mol %, in the range of about 0 to about 2.0 mol %, or in the range of about 0 to about 1.0 mol %, and all subranges therebetween. In other embodiments, the glass is substantially free of Li₂O. In other embodiments, the glass comprises Na₂O in the range of about 0 mol % to about 10 mol %, in the range of about 0 mol % to about 9.28 mol %, in the range of about 0 to about 5 mol %, in the range of about 0 to about 3 mol %, or in the range of about 0 to about 0.5 mol %, and all subranges therebetween. In other embodiments, the glass is substantially free of Na₂O. In some embodiments, the glass comprises K₂O in the range of about 0 to about 12.0 mol %, in the range of about 8 to about 11 mol %, in the range of about 0.58 to about 10.58 mol %, and all subranges therebetween.

The glass substrate used for the GLGP in some embodiments is a high-transmission glass, such as a high-transmission aluminosilicate glass. In certain embodiments, the light guide plate exhibits a transmittance normal to the at least one major surface greater than 90% over a wavelength range from 400 nm to 700 nm. For instance, the light guide plate exhibits greater than about 91% transmittance normal to the at least one major surface, greater than about 92% transmittance normal to the at least one major surface, greater than about 93% transmittance normal to the at least one major surface, greater than about 94% transmittance normal to the at least one major surface, or greater than about 95% transmittance normal to the at least one major surface, over a wavelength range from 400 nm to 700 nm, including all ranges and subranges therebetween.

In certain embodiments, the edge surface of the glass substrate that is configured to receive light from a light source scatters light within an angle less than 12.8 degrees full width half maximum (FWHM) in transmission. In some embodiments, the edge surface is configured to receive light from a light source is processed by grinding the edge without polishing, or by other methods for processing LGPs known to those or ordinary skill in the art, as disclosed in U.S. Published Application No. 2015/0368146, hereby incorporated by reference in its entirety. Alternatively, the GLGP can be provided with a score/break edge with minimal chamfer.

The glass substrate used for the GLGP of some embodiments is chemically strengthened, e.g., by ion exchange. During the ion exchange process, ions within a glass at or near the surface of the glass can be exchanged for larger metal ions, for example, from a salt bath. The incorporation of the larger ions into the glass can strengthen the glass by creating a compressive stress in a near surface region. A corresponding tensile stress can be induced within a central region of the glass to balance the compressive stress.

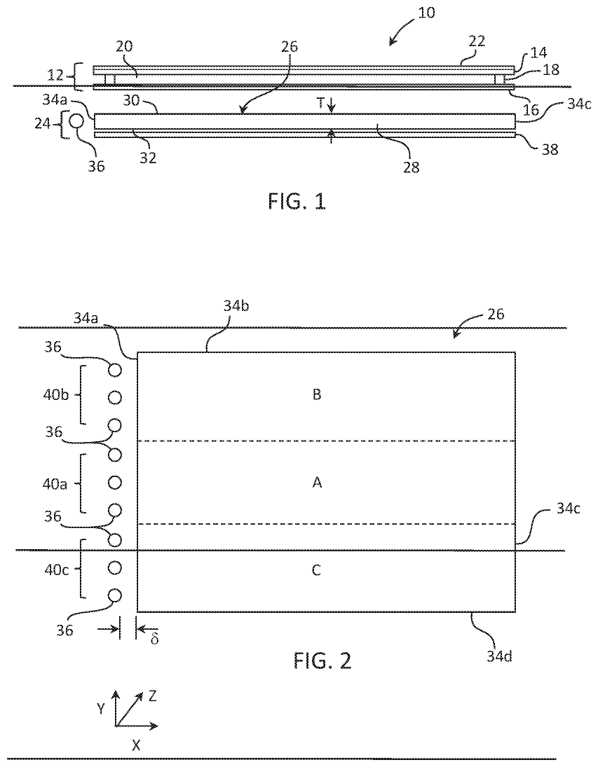

An exemplary LCD display device 10 is shown in FIG. 1 comprising an LCD display panel 12 formed from a first substrate 14 and a second substrate 16 joined by an adhesive material 18 positioned between and around a peripheral edge portion of the first and second substrates. First and second substrates 14, 16 and adhesive material 18 form a gap 20 therebetween containing liquid crystal material. Spacers (not shown) may also be used at various locations within the gap to maintain consistent spacing of the gap. First substrate 14 may include color filter material. Accordingly, first substrate 14 may be referred to as the color filter substrate. On the other hand, second substrate 16 includes thin film transistors (TFTs) for controlling the polarization state of the liquid crystal material, and may be referred to as the backplane. LCD panel 12 may further include one or more polarizing filters 22 positioned on a surface thereof.

LCD display device 10 further comprises BLU 24 arranged to illuminate LCD panel 12 from behind, i.e., from the backplane side of the LCD panel. In some embodiments, the BLU may be spaced apart from the LCD panel, although in further embodiments, the BLU may be in contact with or coupled to the LCD panel, such as with a transparent adhesive. BLU 24 comprises a glass light guide plate (LGP) 26 formed with a glass substrate 28 as the light guide, the glass substrate 28 including a first major surface 30, a second major surface 32, and a plurality of edge surfaces extending between the first and second major surfaces. In embodiments, glass substrate 28 may be a parallelogram, for example a square or rectangle comprising four edge surfaces 34a, 34b, 34c and 34d as shown in FIG. 2 extending between the first and second major surfaces defining an X-Y plane of the glass substrate 28, as shown by the X-Y-Z coordinates. For example, edge surface 34a may be opposite edge surface 34c, and edge surface 34b may be positioned opposite edge surface 34d. Edge surface 34a may be parallel with opposing edge surface 34c, and edge surface 34b may be parallel with opposing edge surface 34d. Edge surfaces 34a and 34c may be orthogonal to edge surfaces 34b and 34d. The edge surfaces 34a-34d may be planar and orthogonal to, or substantially orthogonal (e.g., 90+/−1 degree, for example 90+/−0.1 degree) to major surfaces 30, 32, although in further embodiments, the edge surfaces may include chamfers, for example a planar center portion orthogonal to, or substantially orthogonal to major surfaces 30, 32 and joined to the first and second major surfaces by two adjacent angled surface portions.

First and/or second major surfaces 30, 32 may include an average roughness (Ra) in a range from about 0.1 nanometer (nm) to about 0.6 nm, for example less than about 0.6 nm, less than about 0.5 nm, less than about 0.4 nm, less than about 0.3 nm, less than about 0.2 nm, or less than about 0.1 nm. An average roughness (Ra) of the edge surfaces may be equal to or less than about 0.05 micrometers (μm), for example in a range from about 0.005 micrometers to about 0.05 micrometers.

The foregoing level of major surface roughness can be achieved, for example, by using a fusion draw process or a float glass process followed by polishing. Surface roughness may be measured, for example, by atomic force microscopy, white light interferometry with a commercial system such as those manufactured by Zygo, or by laser confocal microscopy with a commercial system such as those provided by Keyence. The scattering from the surface may be measured by preparing a range of samples identical except for the surface roughness, and then measuring the internal transmittance of each. The difference in internal transmission between samples is attributable to the scattering loss induced by the roughened surface. Edge roughness can be achieved by grinding and/or polishing.

Glass substrate 28 further comprises a maximum glass substrate thickness T in a direction orthogonal to first major surface 30 and second major surface 32. In some embodiments, glass substrate thickness T may be equal to or less than about 3 mm, for example equal to or less than about 2 mm, or equal to or less than about 1 mm, although in further embodiments, glass substrate thickness T may be in a range from about 0.1 mm to about 3 mm, for example in a range from about 0.1 mm to about 2.5 mm, in a range from about 0.3 mm to about 2.1 mm, in a range from about 0.5 mm to about 2.1 mm, in a range from about 0.6 mm to about 2.1 mm, or in a range from about 0.6 mm to about 1.1 mm, including all ranges and subranges therebetween. In some embodiments, thickness of the glass substrate can be in the range from about 0.1 mm to about 3.0 mm (e.g., from about 0.3 mm to about 3 mm, from about 0.4 mm to about 3 mm, from about 0.5 mm to about 3 mm, from about 0.55 mm to about 3 mm, from about 0.7 mm to about 3 mm, from about 1 mm to about 3 mm, from about 0.1 mm to about 2 mm, from about 0.1 mm to about 1.5 mm, from about 0.1 mm to about 1 mm, from about 0.1 mm to about 0.7 mm, from about 0.1 mm to about 0.55 mm, from about 0.1 mm to about 0.5 mm, from about 0.1 mm to about 0.4 mm, from about 0.3 mm to about 0.7 mm, or from about 0.3 mm to about 0.55 mm).

In accordance with embodiments described herein, BLU 24 further comprises an array of light emitting diodes (LEDs) 36 arranged along at least one edge surface (a light injection edge surface) of glass substrate 28, for example edge surface 34a. It should be noted that while the embodiment depicted in FIG. 1 shows a single edge surface 34a injected with light, the claimed subject matter should not be so limited, as any one or several of the edges of an exemplary glass substrate 28 can be injected with light. For example, in some embodiments, the edge surface 34a and its opposing edge surface 34c can both be injected with light. Additional embodiments may inject light at edge surface 34b and its opposing edge surface 34d rather than, or in addition to, the edge surface 34a and/or its opposing edge surface 34c. The light injection surface(s) may be configured to scatter light within an angle less than 12.8 degrees full width half maximum (FWHM) in transmission.

In some embodiments, LEDs 36 may be located a distance 6 from the light injection edge surface, e.g., edge surface 34a, of less than about 0.5 mm. According to one or more embodiments, LEDs 36 may comprise a thickness or height that is less than or equal to thickness T of glass substrate 28 to provide efficient light coupling into the glass substrate.

Light emitted by the array of LEDs is injected through the at least one edge surface 34a and guided through the glass substrate by total internal reflection, and extracted to illuminate LCD panel 12, for example by extraction features on one or both major surfaces 30, 32 of glass substrate 28. Such extraction features disrupt the total internal reflection, and cause light propagating within glass substrate 28 to be directed out of the glass substrate through one or both of major surfaces 30, 32. Accordingly, BLU 24 may further include a reflector plate 38 positioned behind glass substrate 28, opposite LCD panel 12, to redirect light extracted from the back side of the glass substrate, e.g., major surface 32, to a forward direction (toward LCD panel 12). Suitable light extraction features can include a roughed surface on the glass substrate, produced either by roughening a surface of the glass substrate directly, or by coating the sheet with a suitable coating, for example a diffusion film. Light extraction features in some embodiments can be obtained, for example, by printing reflective discrete regions (e.g., white dots) with a suitable ink, such as a UV-curable ink and drying and/or curing the ink. In some embodiments, combinations of the foregoing extraction features may be used, or other extraction features as are known in the art may be employed.

BLU may further include one or more films or coatings (not shown) deposited on a major surface of the glass substrate, for example a quantum dot film, a diffusing film, and reflective polarizing film, or a combination thereof.

Local dimming, e.g., one dimensional (1D) dimming, can be accomplished by turning on selected LEDs 36 illuminating a first region along the at least one edge surface 34a of glass substrate 28, while other LEDs 36 illuminating adjacent regions are turned off.

Conversely, 1D local dimming can be accomplished by turning off selected LEDs illuminating the first region, while LEDs illuminating adjacent regions are turned on.

FIG. 2 shows a portion of an exemplary LGP 26 comprising a first sub-array 40a of LEDs arranged along edge surface 34a of glass substrate 28, a second sub-array 40b of LEDs arranged along edge surface 34a of glass substrate 28, and a third sub-array 40c of LEDs 36 arranged along edge surface 34a of glass substrate 28. Three distinct regions of the glass substrate illuminated by the three sub-arrays are labeled A, B and C, wherein the A region is the middle region, and the B and C regions are adjacent the A region. Regions A, B and C are illuminated by LED sub-arrays 40a, 40b and 40c, respectively. With the LEDs of sub-array 40a in the “on” state and all other LEDs of other sub-arrays, for example the sub-arrays 40b and 40c, in the “off” state, a local dimming index LDI can be defined as 1−(average luminosity of the B, C regions)/(luminosity of the A region). A fuller explanation of determining LDI can be found, for example, in “Local Dimming Design and Optimization for Edge-Type LED Backlight Unit”: Jung, et al., SID 2011 Digest, 2011, pp. 1430-1432, the content of which is incorporated herein by reference in its entirety.

It should be noted that the number of LEDs within any one array or sub-array, or even the number of sub-arrays, is at least a function of the size of the display device, and that the number of LEDs depicted in FIG. 2 are for illustration only and not intended as limiting. Accordingly, each sub-array can include a single LED, or more than one LED, or a plurality of sub-arrays can be provided in a number as necessary to illuminate a particular LCD panel, such as three sub-arrays, four sub-arrays, five sub-arrays, and so forth. For example, a typical 1D local dimming-capable 55″ (139.7 cm) LCD TV may have 8 to 12 zones. The zone width is typically in a range from about 100 mm to about 150 mm, although in some embodiments the zone width can be smaller. The zone length is about the same as a length of glass substrate 28.

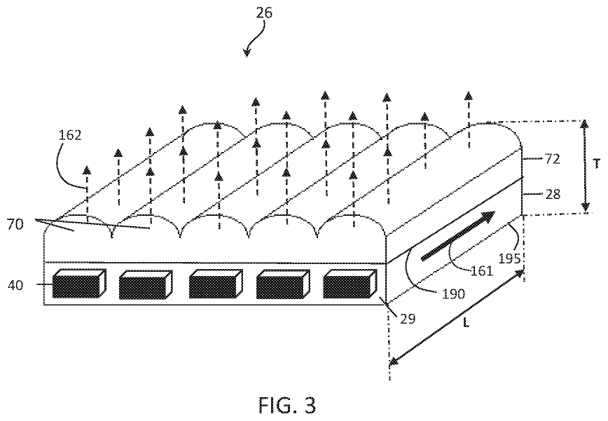

Referring now to FIG. 3, a light guide plate 26 is shown including at least one light source 40 that can be optically coupled to an edge surface 29 of the glass substrate 28, e.g., positioned adjacent to the edge surface 29. As used herein, the term “optically coupled” is intended to denote that a light source is positioned at an edge of the LGP so as to introduce light into the LGP. A light source may be optically coupled to the LGP even though it is not in physical contact with the LGP. Additional light sources (not illustrated) may also be optically coupled to other edge surfaces of the LGP, such as adjacent or opposing edge surfaces.

Light injected into the LGP from a light source 40 may propagate along a length L of the LGP as indicated by arrow 161 due to total internal reflection (TIR), until it strikes an interface at an angle of incidence that is less than the critical angle. TIR is the phenomenon by which light propagating in a first material (e.g., glass, plastic, etc.) comprising a first refractive index can be totally reflected at the interface with a second material (e.g., air, etc.) comprising a second refractive index lower than the first refractive index. TIR can be explained using Snell's law:

n₁ sin(θᵢ)=n₂ sin(θᵣ) which describes the refraction of light at an interface between two materials of differing indices of refraction. In accordance with Snell's law, n₁ is the refractive index of a first material, n₂ is the refractive index of a second material, θᵢ is the angle of the light incident at the interface relative to a normal to the interface (incident angle), and θᵣ is the angle of refraction of the refracted light relative to the normal. When the angle of refraction (θᵣ) is 90°, e.g., sin(θᵣ)=1, Snell's law can be expressed as:

$${θ}_{c} = {θ}_{i} = {sin}^{- 1} ( \frac{{n}_{2}}{{n}_{1}} ) .$$

The incident angle θᵢ under these conditions may also be referred to as the critical angle θ_{c}. Light having an incident angle greater than the critical angle (θᵢ>0) will be totally internally reflected within the first material, whereas light with an incident angle equal to or less than the critical angle (θᵢ≤θ_{c}) will be mostly transmitted by the first material.

In the case of an exemplary interface between air (n₁=1) and glass (n₂=1.5), the critical angle (θ_{c}) can be calculated as 41°. Thus, if light propagating in the glass strikes the air-glass interface at an incident angle greater than 41°, all the incident light will be reflected from the interface at an angle equal to the incident angle. If the reflected light encounters a second interface comprising an identical refractive index relationship as the first interface, the light incident on the second interface will again be reflected at a reflection angle equal to the incident angle.

In some embodiments, a polymeric platform 72 may be disposed on a major surface of the glass substrate 28, such as light emitting surface 190, opposite second major surface 195. The array of microstructures 70 may, along with other optical films (e.g., a reflector film and one or more diffuser films, not shown) disposed on surfaces 190 and 195 of the LGP, direct the transmission of light in a forward direction (e.g., toward a user), as indicated by the dashed arrows 162. In some embodiments, light source 40 may be a Lambertian light source, such as a light emitting diode (LED). Light from the LEDs may spread quickly within the LGP, which can make it challenging to effect local dimming (e.g., by turning off one or more LEDs). However, by providing one or more microstructures on a surface of the LGP that are elongated in the direction of light propagation (as indicated by the arrow 161 in FIG. 3), it may be possible to limit the spreading of light such that each LED source effectively illuminates a narrow strip of the LGP. The illuminated strip may extend, for example, from the point of origin at the LED to a similar end point on the opposing edge. As such, using various microstructure configurations, it may be possible to effect one dimensional (1D) local dimming of at least a portion of the LGP in a relatively efficient manner.

### EXAMPLES

Various embodiments will be further clarified by the following non-limiting Examples.

Glass compositions with the compositions shown Table 1 were prepared and contained 10 ppm Fe, zero Cr, and zero Ni. Measurement of color shift data was accomplished by using three different thicknesses of samples (2, 4, 8 mm thicknesses), by measuring transmission as a function of wavelength for each thickness using a UV-VIS spectrometer, which allows the calculation of the absorption coefficient via the slope of log (transmission) versus thickness. With the values obtained, absorption was scaled based on the concentration of the metals to obtain transmission for any given metal content.

TABLE 1

| Example | SiO₂ | Al₂O₃ | Na₂O | K₂O | ZnO | MgO | SrO | Δy | Δy Rank |
|---|---|---|---|---|---|---|---|---|---|
| 1 | 80.28 | 0 | 0 | 9.69 | 0 | 9.83 | 0 | −0.000049 | 7 |
| 2 | 80.48 | 0 | 0 | 9.75 | 2.86 | 6.75 | 0 | −0.000591 | 4 |
| 3 | 80.62 | 0 | 1.12 | 8.56 | 2.8 | 6.71 | 0 | −0.001015 | 2 |
| 4 | 80.19 | 0 | 0 | 8.91 | 0 | 8.75 | 1.94 | −0.00044 | 6 |
| Comp. 5 | 80.3 | 0 | 4.91 | 4.86 | 0 | 9.68 | 0 | 0.0001 | 8 |
| 6 | 80.48 | 0 | 0.98 | 8.75 | 1.86 | 7.75 | 0 | −0.000623 | 3 |
| 7 | 80.27 | 0 | 0 | 9.83 | 4.87 | 4.83 | 0 | −0.00051 | 5 |
| 8 | 76.4 | 5.2 | 11.66 | 0 | 0 | 6.6 | 0 | −0.001772 | 1 |

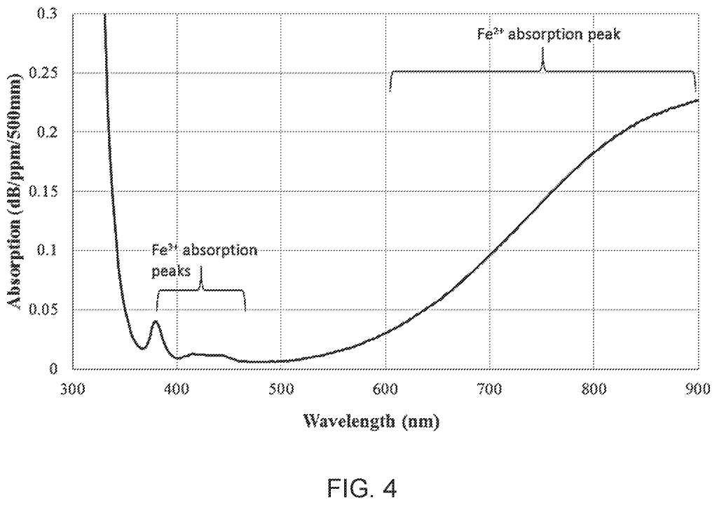

FIG. 4 is a graph which shows the overall absorption curve of Fe, which is composed of both Fe²⁺ and Fe³⁺ redox states, in a prior art glass composition used in the manufacture of glass light guide plates.

If Fe is the only tramp metal present in the glass, the transmission of the glass will look like an inverted version of absorption curve shown in FIG. 4, scaled to the proper concentration of Fe. The glass composition in FIG. 4 is Example 8 in Table 1 shown below.

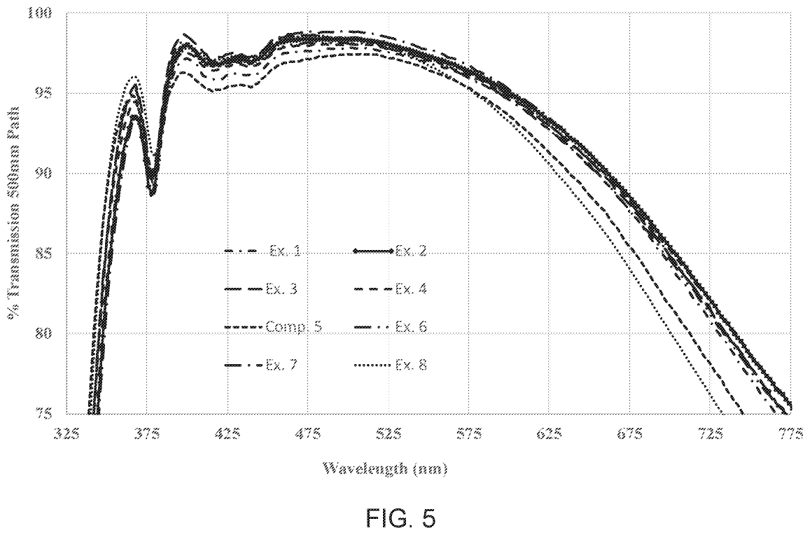

FIG. 5 is a graph which depicts the transmission of seven exemplary glass compositions and one comparative glass composition which can be used in the manufacture of glass light guide plates and containing about 10 ppm of Fe. Composition and color shift for the same glasses are shown in Table 1, with the oxides in mol %. Of these eight compositions only one, Comparative Example 5 (Comp. 5) exhibited a positive color shift. This is due to the greater amount and/or extinction coefficient of the Fe³⁺ state relative to the Fe²⁺ state.

Variation in the color shift of the glasses shown in Table 1 can be attributed to changes in the Fe³⁺:Fe²⁺ redox equilibrium. This is an effect of the glass chemistry. Example 8 contains only sodium as the alkali addition. Sodium serves to stabilize the Fe²⁺ redox state, thus reducing the red and increase the blue transmissions respectively. In turn, this decreases the color shift. All other compositions shown contain potassium as the predominant alkali. Potassium does not stabilize the Fe²⁺ state as well as sodium, which explains the higher values of Δy. However other oxides can be added to help shift the redox equilibrium towards Fe²⁺, or reduce the Fe³⁺ extinction coefficient. In particular, zinc oxide is the next best oxide to sodium to add to glasses low color shift. In Table 1 the glasses are ranked in terms of color shift from best to worst. Example 8 has the lowest color shift due to it being a sodium only composition. Example 3, ranked second, contains a combination of Zn, K and Na to achieve its low color shift. Examples 6, 2, and 7 contain Zn and K. The highest color shift exhibited by Example 4, Comparative Example 5, and Example 1, which do not contain Na or Zn, an only K.

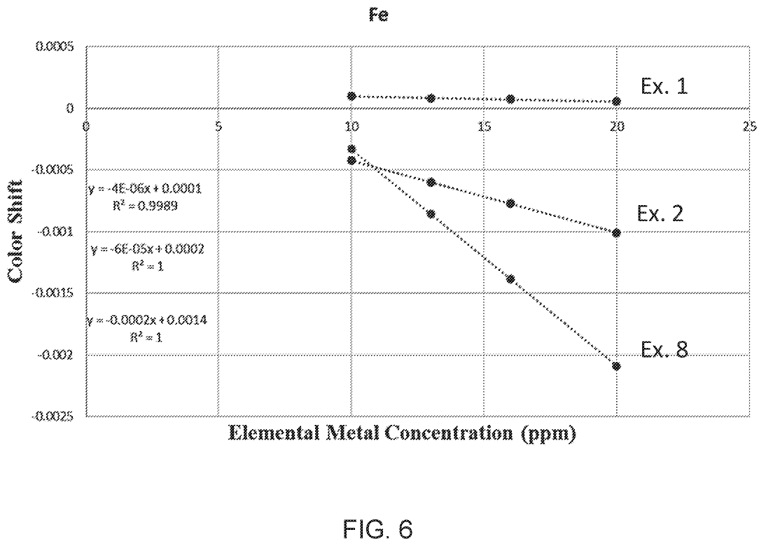

Fluctuation in the Fe concentration also has an effect on the color shift of the glass. The effect of concentration is also composition dependent, albeit indirectly. The magnitude of the color shift change with concentration is influenced by the redox equilibrium and the extinction coefficients of each ionic state. FIG. 6 is a graph which shows the effect of increasing Fe concentration for three different compositions: Examples 2, 1, and 8. For each of these three glasses, color shift becomes more negative with increasing concentration. However, the rate at which color shift decreases is much larger for Example 8 than for Example 1. This is again related to the redox ratio and extinction coefficients for these glasses. Both Example 8 and Example 2 stabilize Fe²⁺ and/or reduce the extinction coefficient of the Fe³⁺ ion relative to Example 1. This demonstrates that color shift can be affected with a Fe addition much more easily with these compositions.

Unlike Fe, Ni is generally only present in glass in the Ni²⁺ state. Although it does not change redox state, the placement and magnitude of the absorption peaks associated with Ni²⁺ drastically effects color shift as a function of composition. The shape of this absorption in the visible determines the potential for negative color shift when Ni is present.

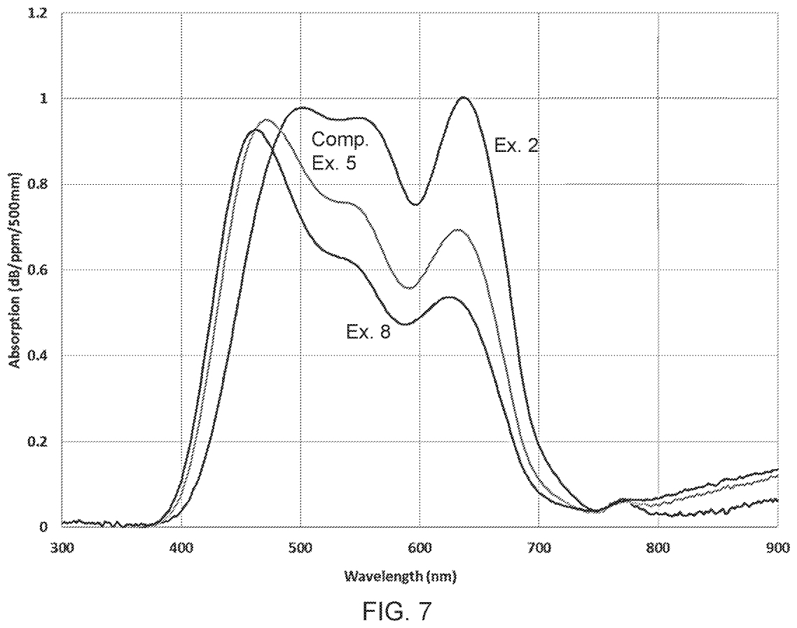

Compositionally, the overall shape of the absorption curve is affected by the constitution of the alkali present in the glass, as shown in FIG. 7. Glasses containing only Na as the alkali addition look similar to that shown in FIG. 7 for Example 8. The peak in absorption occurs almost exactly at 450 nm. As the alkali is changed from Na-only to a combination of K and Na, and then finally to a K-only glass, the absorption curve evolves from that of Example 8, to Comparative Example 5, and finally to Example 2. As can be seen in FIG. 7, the maximum absorption in the blue shifts to longer wavelengths and the absorption in the green and red portions of the spectrum increase. This green shift, as the alkali content moves towards K-only compositions, creates a negative color shift. As can be seen from FIG. 7, the higher the red absorption relative to the green and blue, the lower the value of color shift.

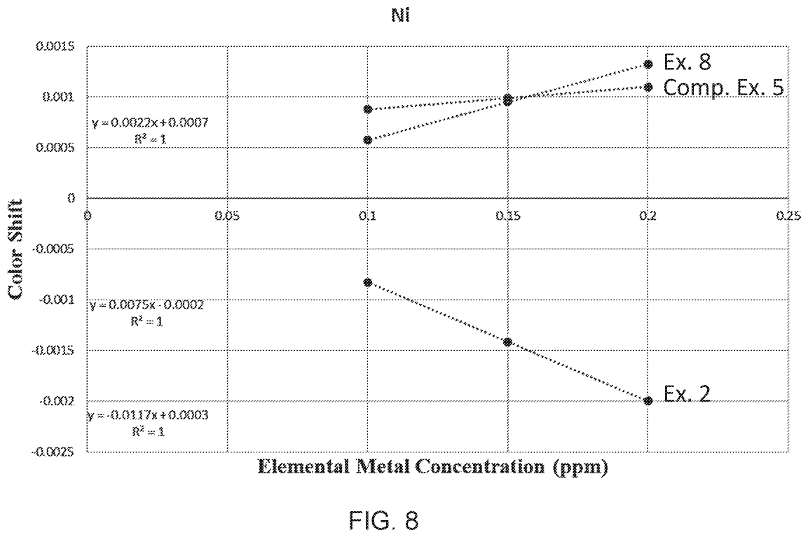

Ni concentration, like Fe concentration, also has a significant effect on color shift. Unlike Fe, redox does not play a role in concentration dependence of color shift due to Ni absorption because Ni is only present in the Ni²⁺ state. However, because of the shape and placement of Ni absorption, concentration plays a significant role in the color shift. FIG. 8 is a graph depicting the magnitude of color shift change as a function of concentration for the Example 8, Comparative Example 5 and Example 2 compositions. Color shift for Example 8 suffers significantly as Ni concentration increases due to the high blue absorption and lower green and red absorption, shown in FIG. 8. Example 5 color shift also suffers, though not nearly as much as Example 8. The higher green and red absorption serve to reduce the rate of the color shift increase. In Example 2, the rate of change of the color shift is both larger than for Example 5 and Example 2, as well as negative. This is due to the very similar absorption of the Ni in all three regions of the visible spectrum. This pattern is true not only for Example 2, but similar light guide plate glass compositions that contain potassium as the only alkali addition. Thus the addition of Ni to any K-only light guide plate glass composition will reduce the absolute transmission, but will also drive the color shift lower. With a high enough Ni concentration the color shift will become negative.

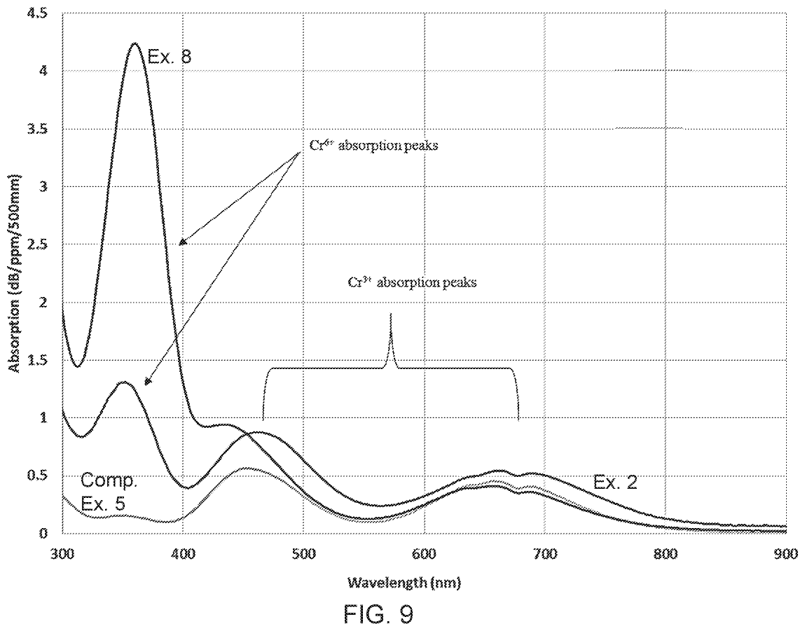

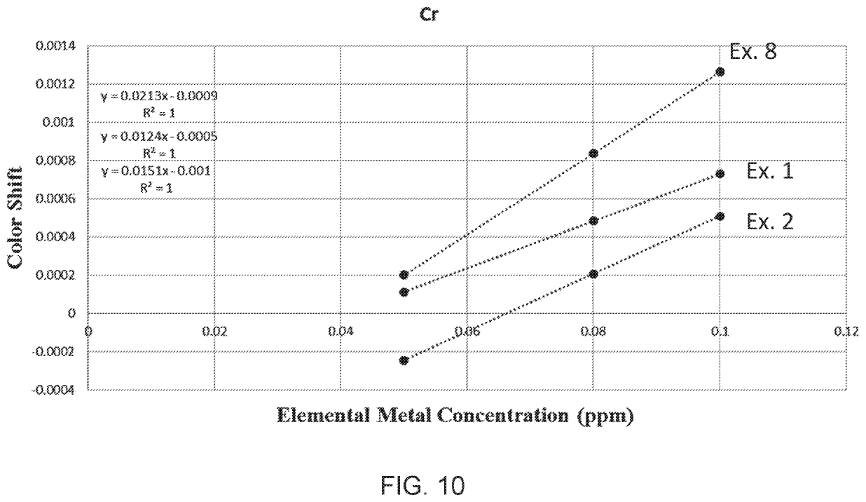

Cr, like Fe, has two well-known redox states in glass products; Cr³⁺ and Cr⁶⁺. Unlike Fe, or Ni, the absorption of either Cr ion in the glass is not beneficial for producing low color shift. Absorption of Cr in Example 8, Comparative Example 5 and Example 2 is shown in FIG. 9. In general, for glass light guide plate composition glasses, Cr³⁺ is more commonly observed than Cr⁶⁺. The peak locations of Cr³⁺ absorption in the visible spectrum are approximately 450 nm and 650 nm. Increased absorption in the blue, at 450 nm, increases the color shift of the glass. If Cr⁶⁺ is present in conjunction with Cr³⁺, blue absorption is increased even more as the Cr⁶⁺ absorption peaks in the ultraviolet range (UV) but tails into the blue overlapping the Cr³⁺ peak. The absorption for Example 8 shown in FIG. 9 is an example of this phenomenon. Because of the shape and placement of the absorption spectrum, there is no beneficial concentration of Cr for color shift. FIG. 10 is a graph which depicts the rate of change of color shift with Cr concentration for three representative glasses. Color shift for Example 8 increases the most quickly, due to the existence of both Cr³⁺ and Cr⁶⁺ absorption in the blue. Achieving a negative color shift glass will require control of the Cr content to very low amounts to avoid counter acting the benefits of Fe and Ni in the glass.

Tables 2 and 3 show two different tramp metal concentrations along with the corresponding color shift for the glass compositions referenced above. As can be seen from the tables, color shift varies based on composition, and metals content.

Table 2 shows transmission at several wavelengths and color shift for several exemplary glass compositions, which are the same compositions as in Table 1, except the glass compositions contained 10.5 ppm Fe, 0.08 ppm Cr and 0.06 ppm Ni.

TABLE 2

| | Comp. | | | Comp. | Comp. | | | Comp. |
|---|---|---|---|---|---|---|---|---|
| Example | 1A | 2A | 3A | 4A | 5A | 6A | 7A | 8A |
| 450 nm | 94.61 | 95.32 | 95.50 | 94.83 | 93.93 | 95.10 | 95.64 | 94.89 |
| 550 nm | 95.13 | 95.44 | 95.43 | 95.47 | 95.09 | 95.35 | 95.88 | 95.54 |
| 630 nm | 90.09 | 90.55 | 90.18 | 90.45 | 88.84 | 90.06 | 90.58 | 88.17 |
| 450-550 | −0.52 | −0.12 | 0.07 | −0.64 | −1.16 | −0.26 | −0.24 | −0.65 |
| 450-630 | 4.52 | 4.77 | 5.32 | 4.38 | 5.09 | 5.04 | 5.06 | 6.72 |
| Δy | .000373 | −0.000116 | −0.000484 | 0.000519 | 0.001183 | −0.000178 | −0.000071 | 0.000297 |

Examples 2A, 3A, 6A and 8A satisfied the relationship

$${T}_{450 n m} - {T}_{550 n m} \geq - 0.3 .$$

Accordingly, each of Examples 2A, 3A, 6A and 8A exhibited a negative color shift.

Table 3 shows transmission at several wavelengths and color shift for several exemplary glass compositions, which are the same compositions as in Table 1, except the glass compositions contained 7 ppm Fe, 0.05 ppm Cr and 0.2 ppm Ni.

TABLE 3

| | | | | | Comp. | | | Comp. |
|---|---|---|---|---|---|---|---|---|
| Example | 1B | 2B | 3B | 4B | 5B | 6B | 7B | 8B |
| 450 nm | 94.28 | 94.93 | 94.35 | 94.31 | 93.07 | 94.27 | 95.14 | 93.54 |
| 550 nm | 93.48 | 93.60 | 93.28 | 94.06 | 94.09 | 93.46 | 93.82 | 94.88 |
| 630 nm | 90.13 | 90.29 | 89.83 | 90.79 | 90.11 | 89.96 | 90.20 | 90.18 |
| 450-550 | 0.80 | 1.33 | 1.07 | 0.25 | −1.02 | 0.80 | 1.32 | −1.34 |
| 450-630 | 3.35 | 3.31 | 3.45 | 3.26 | 3.99 | 3.51 | 3.62 | 4.70 |
| Δy | −0.00131 | −0.002 | −0.00174 | −0.00058 | 0.00107 | −0.00147 | −0.00208 | 0.001324 |

Examples 1B, 2B, 3B, 4B, 6B and 7B satisfied the relationship

$${T}_{450 n m} - {T}_{550 n m} \geq - 0.3 .$$

Accordingly, each of Examples 1B, 2B, 3B, 4B, 6B and 7B exhibited a negative color shift.

Ranges expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein, for example up, down, right, left, front, back, top, bottom are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. As used herein, the singular forms “a,” “an” and “the” include plural referents unless the context clearly dictates otherwise. Thus, for example, reference to “a” component includes aspects having two or more such components, unless the context clearly indicates otherwise.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

1. A light guide plate, comprising:
a glass substrate comprising two major surfaces defining a thickness and an edge surface configured to receive light from a light source and the glass substrate configured to distribute the light from the light source, the glass substrate containing amounts of Fe, Cr and Ni metals such that the glass substrate exhibits a measured color shift Δy that is negative.

2. The light guide plate of claim 1, wherein the glass substrate comprises a greater amount of a Fe³⁺ state relative to a Fe²⁺ state.

3. The light guide plate of claim 1, wherein transmission of light at 450 nm, T_{450 nm}, and transmission of light at 550 nm, T_{550 nm}, satisfies the following equation:
$${T}_{450 n m} - {T}_{550 n m} \geq - 0.3 .$$

4. The light guide plate of claim 1, wherein transmission of light at 450 nm, T_{450 nm}, and transmission of light at 550 nm, T_{550 nm}, satisfies the following equation:
$${T}_{450 n m} - {T}_{550 n m} \geq - 0.2 .$$

5. The light guide plate of claim 3, wherein the glass substrate comprises an aluminosilicate glass, a borosilicate glass, or a soda-lime glass.

6. The light guide plate of claim 3, the glass substrate comprising, on a mol % oxide basis:
50-90 mol % SiO₂,
0-20 mol % Al₂O₃,
0-20 mol % B₂O₃, and
0-25 mol % RₓO,
wherein x is 2 and R is chosen from Li, Na, K, Rb, Cs, and combinations thereof, or
wherein x is 1 and R is chosen from Zn, Mg, Ca, Sr, Ba, and combinations thereof,
and the glass substrate further comprises at least 0.5 mol % of one oxide selected from Li₂O, Na₂O, K₂O, CaO and MgO.

7. The light guide plate of claim 3, wherein the glass substrate comprises, on a mol % oxide basis:
65-85 mol % SiO₂;
0-13 mol % Al₂O₃;
0-12 mol % B₂O₃;
0-2 mol % Li₂O;
0-14 mol % Na₂O;
0-12 mol % K₂O;
0-4 mol % ZnO;
0-12 mol % MgO;
0-5 mol % CaO;
0-7 mol % SrO;
0-5 mol % BaO; and
0.01-1 mol % SnO₂.

8. A display product comprising:
a light source;
a reflector; and
the light guide plate of claim 1.

9. A display product comprising:
a light source;
a reflector; and
the light guide plate of claim 3.

10. The display product of claim 9, wherein the light source comprises a light emitting diode optically coupled to the edge surface of the glass substrate.

11. A method of processing a glass substrate for use as a light guide plate, the method comprising:
selecting raw materials for a glass batch and processing the raw materials to provide a glass composition;
forming the glass composition into the glass substrate comprising two major surfaces defining a thickness and an edge surface, the glass composition containing amounts of Fe, Cr and Ni metals such that the glass substrate exhibits a negative measured color shift Δy.

12. The method of claim 11, wherein the glass substrate comprises a greater amount of a Fe³⁺ state relative to a Fe²⁺ state.

13. The method of claim 11, wherein transmission of light at 450 nm, T_{450 nm}, and transmission of light at 550 nm, T_{550 nm}, through the glass substrate satisfies the following equation: T_{450 nm}−T_{550 nm}≥−0.3.

14. The method of claim 11, wherein transmission of light at 450 nm, T_{450 nm}, and transmission of light at 550 nm, T_{550 nm}, through the glass substrate satisfies the following equation: T_{450 nm}−T_{550 nm}≥−0.2.

15. The method of claim 13, wherein the glass substrate comprises an aluminosilicate glass, a borosilicate glass, and a soda-lime glass.

16. The method of claim 13, wherein the glass substrate comprises, on a mol % oxide basis:
50-90 mol % SiO₂,
0-20 mol % Al₂O₃,
0-20 mol % B₂O₃, and
0-25 mol % RₓO,
wherein x is 2 and R is chosen from Li, Na, K, Rb, Cs, and combinations thereof, or
wherein x is 1 and R is chosen from Zn, Mg, Ca, Sr, Ba, and combinations thereof,
and the glass substrate further comprises at least 0.5 mol % of one oxide selected from Li₂O, Na₂O, K₂O, CaO and MgO.

17. The method of claim 13, wherein the glass substrate comprises, on a mol % oxide basis:
65-85 mol % SiO₂;
0-13 mol % Al₂O₃;
0-12 mol % B₂O₃;
0-2 mol % Li₂O;
0-14 mol % Na₂O;
0-12 mol % K₂O;
0-4 mol % ZnO;
0-12 mol % MgO;
0-5 mol % CaO;
0-7 mol % SrO;
1-5 mol % BaO; and
0.01-1 mol % SnO₂.
